(19) United States
(12) Patent Application Publication
(10) Pub. No.: US 2024/0354768 A1
(43) Pub. Date: Oct. 24, 2024

(54) REIMBURSEMENT CODE-BASED ENTRUSTED WITH HOLDING PROCESSING

(71) Applicant: Alipay (Hangzhou) Information Technology Co., Ltd., Hangzhou (CN)

(72) Inventors: Jianhui HUA, Hangzhou (CN); Qin TU, Hangzhou (CN); Wenhu KAN, Hangzhou (CN); Jian LIU, Hangzhou (CN); Yue WANG, Hangzhou (CN)

(21) Appl. No.: 18/560,757

(22) PCT Filed: Jul. 1, 2022
(86) PCT No.: PCT/CN2022/103342

§ 371 Date: Nov. 14, 2023

(30) Foreign Application Priority Data
May 25, 2021 (CN) 202110572758.2

(51) Int. Cl. G06Q 20/40; G06Q 40/12

(52) U.S. Cl. CPC G06Q 20/405; G06Q 40/125

(57) ABSTRACT

Embodiments of this specification provide a reimbursement code-based entrusted withholding processing method and apparatus. The reimbursement code-based entrusted withholding processing method includes the following: performing expense control verification on a payment order of an institution member based on an expense control rule configured for a reimbursement code of an institution; if the expense control verification is passed, detecting whether the reimbursement code is bound to a fund account opened by the institution on a financial platform; and if yes, generating an entrusted withholding request of the payment order, and submitting the entrusted withholding request to the financial platform, to perform entrusted withholding processing of the payment order based on the fund account.

### TECHNICAL FIELD

This specification relates to the field of data processing technologies, and in particular, to a reimbursement code-based entrusted withholding processing method and apparatus.

### BACKGROUND

With the development of Internet technologies, e-bills have been widely used. Like ordinary paper bills, the e-bills have codes issued by tax authorities, and therefore, have the same voucher effect as the ordinary paper bills. However, the e-bills are more convenient than the ordinary paper bills in various aspects such as invoicing and reimbursement. In a process of using bills to reimburse for expenses, it is necessary to first fill out electronic reports such as a reimbursement application form, and then submit the filled reimbursement application form to a reviewer for review. The bills are reimbursed for after the review is passed. The whole reimbursement process is relatively cumbersome, bill item type errors and the like usually occur in the reimbursement process, and a person who applies for bill reimbursement and the reviewer need to spend much time and energy.

### SUMMARY

One or more embodiments of this specification provide a reimbursement code-based entrusted withholding processing method. The reimbursement code-based entrusted withholding processing method includes the following: performing expense control verification on a payment order of an institution member based on an expense control rule configured for a reimbursement code of an institution; if the expense control verification is passed, detecting whether the reimbursement code is bound to a fund account opened by the institution on a financial platform; and if yes, generating an entrusted withholding request of the payment order, and submitting the entrusted withholding request to the financial platform, to perform entrusted withholding processing of the payment order based on the fund account.

One or more embodiments of this specification provide a reimbursement code-based entrusted withholding processing apparatus, including: an expense control verification module, configured to perform expense control verification on a payment order of an institution member based on an expense control rule configured for a reimbursement code of an institution; an account opening detection module, configured to: if the expense control verification is passed, detect whether the reimbursement code is bound to a fund account opened by the institution on a financial platform, where if yes, an entrusted withholding processing module is run; and the entrusted withholding processing module, configured to generate an entrusted withholding request of the payment order, and submit the entrusted withholding request to the financial platform, to perform entrusted withholding processing of the payment order based on the fund account.

One or more embodiments of this specification provide a reimbursement code-based entrusted withholding processing device, including a processor and a memory configured to store computer executable instructions. When the computer executable instructions are executed, the processor is enabled to: perform expense control verification on a payment order of an institution member based on an expense control rule configured for a reimbursement code of an institution; if the expense control verification is passed, detect whether the reimbursement code is bound to a fund account opened by the institution on a financial platform; and if yes, generate an entrusted withholding request of the payment order, and submit the entrusted withholding request to the financial platform, to perform entrusted withholding processing of the payment order based on the fund account.

One or more embodiments of this specification provide a storage medium, configured to store computer executable instructions. When the computer executable instructions are executed, the following procedure is implemented: performing expense control verification on a payment order of an institution member based on an expense control rule configured for a reimbursement code of an institution; if the expense control verification is passed, detecting whether the reimbursement code is bound to a fund account opened by the institution on a financial platform; and if yes, generating an entrusted withholding request of the payment order, and submitting the entrusted withholding request to the financial platform, to perform entrusted withholding processing of the payment order based on the fund account.

### BRIEF DESCRIPTION OF DRAWINGS

To describe the technical solutions in one or more embodiments of this specification or in the existing technology more clearly, the following briefly describes the accompanying drawings needed for describing the embodiments or the existing technology. Clearly, the accompanying drawings in the following description merely show some embodiments of this specification, and a person of ordinary skill in the art can still derive other drawings from these accompanying drawings without creative efforts.

FIG. 1 is a flowchart illustrating processing of a reimbursement code-based entrusted withholding processing method, according to one or more embodiments of this specification;

FIG. 2 is a flowchart illustrating processing of a reimbursement code-based entrusted withholding processing method applied to an enterprise reimbursement scenario, according to one or more embodiments of this specification;

FIG. 3 is a schematic diagram illustrating a reimbursement code-based entrusted withholding processing apparatus, according to one or more embodiments of this specification; and

FIG. 4 is a schematic diagram illustrating a structure of a reimbursement code-based entrusted withholding processing device, according to one or more embodiments of this specification.

### DESCRIPTION OF EMBODIMENTS

To make a person skilled in the art understand the technical solutions in one or more embodiments of this specification better, the following clearly and comprehensively describes the technical solutions in the one or more embodiments of this specification with reference to the accompanying drawings in the one or more embodiments of this specification. Clearly, the described embodiments are merely some but not all of the embodiments of this specification. All other embodiments obtained by a person of ordinary skill in the art based on the one or more embodiments of this specification without creative efforts shall fall within the protection scope of this specification.

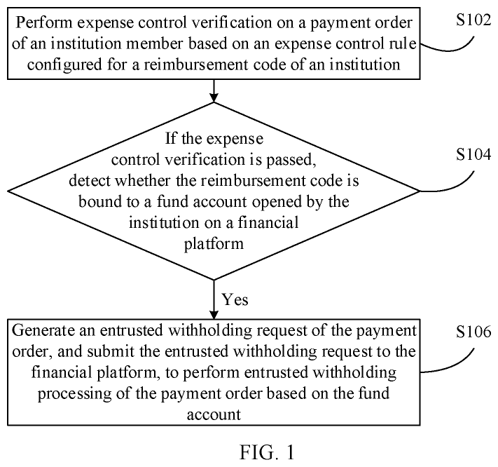

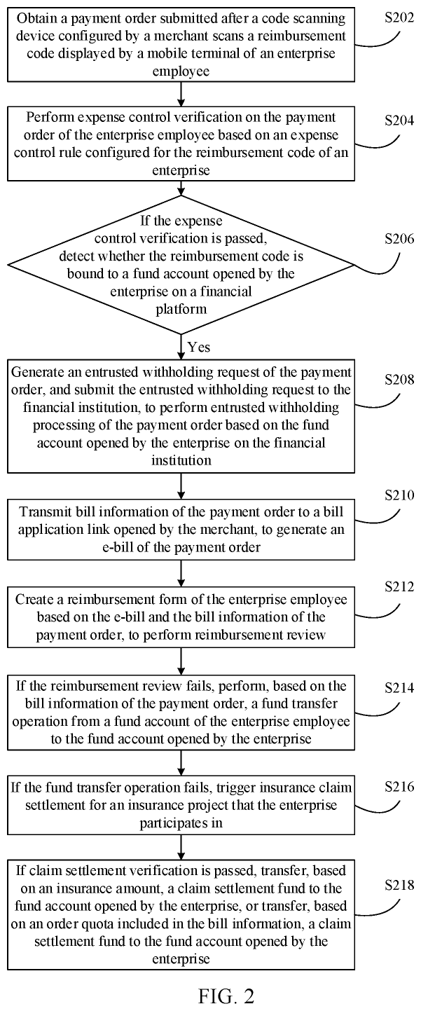

This specification provides embodiments of a reimbursement code-based entrusted withholding processing method. FIG. 1 is a flowchart illustrating processing of a reimbursement code-based entrusted withholding processing method, according to an embodiment. FIG. 2 is a flowchart of processing of a reimbursement code-based entrusted withholding processing method applied to an enterprise reimbursement scenario, according to an embodiment.

Referring to FIG. 1, the reimbursement code-based entrusted withholding processing method provided in this embodiment specifically includes step S102 to step S106.
Step S102: Perform expense control verification on a payment order of an institution member based on an expense control rule configured for a reimbursement code of an institution.

According to the reimbursement code-based entrusted withholding processing method provided in this embodiment, entrusted withholding processing of payment is performed on the payment order of the institution member by using the reimbursement code of the institution as the core. Specifically, expense control verification is performed on the payment order based on the expense control rule configured by the institution for the reimbursement code, to verify whether the payment order of the institution member satisfies a corresponding reimbursement condition configured by the institution. After the verification is passed, it is further detected whether the institution that reimbursement code belongs to opens a fund account for performing entrusted withholding of payment on a financial platform. If the institution opens the fund account, the financial platform performs entrusted withholding processing on the order, to reduce fund pressure of the institution and also improve reimbursement processing efficiency.

The institution described in this embodiment includes various forms of organizations such as enterprises, public institutions, social groups, and firms. In addition, the institution includes not only an organization of a current level, but also an internal organization of the institution, for example, an enterprise department or branch. The institution member includes institution staff and related personnel.

The reimbursement code is an institution code that is set by the institution for payment, invoicing, and reimbursement of the institution member. The institution code can uniquely identify the institution. The institution code can exist in a form of an identification code such as a QR code, a barcode, or an audio code. Integration of payment, invoicing, and reimbursement can be implemented by using the reimbursement code. In addition, the reimbursement code can be further used to identify a membership of the institution member in the institution. For example, the reimbursement code is used as a digital work card of an enterprise employee, and the enterprise employee can obtain, by using the reimbursement code as a voucher, welfare and subsidies issued by the enterprise.

The expense control rule is used to verify whether the payment order submitted by the institution member satisfies the reimbursement condition configured by the institution. For example, an enterprise code of an enterprise can be used by an enterprise employee for payment in scenarios of business trip, business travel, hospitality, team building, office procurement, welfare/subsidy issuing, etc. An expense generated by payment that satisfies a reimbursement condition that is set by the enterprise is borne by the enterprise, so that automatic reimbursement or employee discounts are implemented. Optionally, at least one reimbursement category of the reimbursement code is configured in the expense control rule, and the reimbursement category is associated with at least one expense control element. The expense control element includes at least one of the following: a time element, an object compliance element, a quota element, and a location element. The reimbursement category includes but is not limited to business trip, business travel, hospitality, team building, office procurement, welfare/subsidy issuing.

The time element is used to verify whether a consumption time that the institution member applies for reimbursement satisfies regulations of the institution. The object compliance element is used to verify whether a consumption object that the institution member applies for reimbursement satisfies the regulations of the institution. For example, the enterprise specifies that an expense generated by a company bus or a bus on a specific bus line can be reimbursed for. If a vehicle used by an enterprise employee does not satisfies the regulations, reimbursement cannot be performed. The quota element is used to verify whether an amount that the institution member applies for reimbursement satisfies the regulations of the institution. The location element is used to verify whether geographic location information of a place where the institution member applies for reimbursement satisfies the regulations of the institution.

During specific implementation, in a process of performing expense control verification on the payment order of the institution member based on the expense control rule configured for the reimbursement code of the institution member, a target reimbursement category that matches the payment order in the at least one reimbursement category of the expense control rule is first determined, and then it is verified whether element information recorded in the payment order falls within a value range of an expense control element associated with the target reimbursement category. If yes, it is determined that the payment order passes the verification on the target reimbursement category, in other words, a verification result of performing expense control verification on the payment order is that the verification is passed. If no, it is determined that the payment order fails to pass the verification on the target reimbursement category, in other words, a verification result of performing expense control verification on the payment order is that the verification fails.

Specifically, when the expense control verification fails, to ensure that processing of the payment order of the institution member is not interrupted, payment failure reminder information is delivered to the institution member, a fund is transferred from a member account of the institution member, and the transfer fund is transferred to an account of the order participant (for example, a merchant that trades with the institution member).

It is worthwhile to note that verifying whether the element information recorded in the payment order falls within the value range of the expense control element associated with the target reimbursement category is specifically verifying whether each piece of element information recorded in the payment order satisfies a corresponding expense control element, in other words, whether each piece of element information falls within a value range of a corresponding expense control element; and if any piece of element information does not fall within a value range of a corresponding expense control element, determining that the payment order fails to pass the verification on the target reimbursement category; or if each piece of element information falls within the value range of the corresponding expense control element, determining that the payment order passes the verification on the target reimbursement category.

For example, for a consumption order submitted by an enterprise employee, the consumption order is a ticket order, and matches a business trip category in an expense control rule configured for a reimbursement code of an enterprise. In this case, it is verified whether element information recorded in the consumption order satisfies a time element, a vehicle type element, and a quota element that are associated with the business trip category. Specifically, it is verified whether time information recorded in the consumption order satisfies a value range of the time element (a business trip time is MM 01, YYYY to MM 03, YYYY), it is verified whether vehicle information recorded in the consumption order satisfies a value range of the vehicle element (business trip reimbursement vehicle types include second-class seats on a high-speed train and hard seats and hard sleepers on an ordinary train), and it is verified whether amount information recorded in the consumption order satisfies a value range of the quota element (a maximum reimbursement quota for a single time is 1000 yuan).

When the institution has activated the reimbursement code, the institution can actively invite the institution member to activate permission to use the reimbursement code, so that the institution member uses the reimbursement code for payment, invoicing, and reimbursement in scenarios of business trip, business travel, hospitality, term building, office procurement, welfare/subsidy payment, etc. A process in which the institution actively invites the institution member to activate the permission to use the reimbursement code specifically includes: sending an activation invitation of the reimbursement code to a to-be-authorized member based on an activation request submitted by the institution for the to-be-authorized member; if a confirmation instruction submitted by the to-be-authorized member for the activation invitation is detected, performing identity verification processing on the to-be-authorized member; and when the identity verification processing succeeds, granting the permission on the reimbursement code to the to-be-authorized member, and establishing a mapping relationship between the to-be-authorized member and institution keyword information of the institution. The institution keyword information includes title information of the institution.

After the institution grants the permission to use the reimbursement code to the institution member, the institution member can access the reimbursement code by using a reimbursement code service provided by a third-party application. For example, an enterprise employee who has been granted permission on the reimbursement code can access a reimbursement code of the enterprise by using a reimbursement code service of a payment application installed on a terminal of the institution member.

Similarly, when the institution has activated the reimbursement code, the institution member of the institution can alternatively actively apply for permission to use the reimbursement code, specifically including: obtaining a permission activation application submitted by a to-be-authorized member after the to-be-authorized member scans an identification code of the institution by using a terminal of the member, where the identification code includes the reimbursement code; reviewing the to-be-authorized member based on the permission activation application; and if the review is passed, granting the permission on the reimbursement code to the to-be-authorized member, and establishing a mapping relationship between the to-be-authorized member and institution keyword information of the institution.

In addition, when the verification result of performing expense control verification on the payment order is that the verification fails, to improve perception of the institution member for the expense control rule configured for the reimbursement code to increase a success rate of subsequently performing payment processing by the institution member by using the reimbursement code, if the expense control verification fails after expense control verification is performed on the payment order of the institution member, payment failure reminder information is delivered to the institution member, and/or payment processing of the payment order is performed based on a member account of the institution member.
Step S104: If the expense control verification is passed, detect whether the reimbursement code is bound to a fund account opened by the institution on the financial platform.

In this embodiment, to improve enthusiasm of the institution for using a reimbursement code service from the institution side, the financial platform is introduced in the reimbursement code service, the institution opens the fund account on the financial platform, and entrusted withholding processing of payment is performed on the payment order of the institution member by using the fund account opened by the institution on the financial platform. It is worthwhile to note that an actual fund expense party during entrusted withholding processing of payment is the financial platform. Specifically, the financial platform transfers a fund to the fund account opened by the organization, to perform entrusted withholding of payment on the payment order of the institution member. In an optional implementation provided in this embodiment, the fund account is specifically opened by using the following method: opening the fund account of the institution based on an account application submitted by the institution, and signing a term withholding agreement in which the financial platform performs withholding for a disbursement fund of the fund account based on a settlement term; and establishing a binding relationship between the fund account and the reimbursement code.

During specific implementation, when the verification result obtained after expense control verification is performed on the payment order of the institution member based on the expense control rule configured for the reimbursement code of the institution in the above-mentioned step is that the expense control verification is passed, it is detected whether the reimbursement code is bound to the fund account that the institution opens on the financial platform. If the fund account is opened, the following step S106 is performed to generate an entrusted withholding request of the payment order and submit the entrusted withholding request to the financial platform. If the fund account is not opened, payment is performed on the payment order of the institution member based on a fund account of the institution or a fund account bound to the reimbursement code.
Step S106: Generate the entrusted withholding request of the payment order, and submit the entrusted withholding request to the financial platform, to perform entrusted withholding processing of the payment order based on the fund account.

In an optional implementation provided in this embodiment, the entrusted withholding processing performed on the payment order based on the fund account that is opened by the institution on the financial platform and bound to the reimbursement code specifically includes: triggering a borrowing disbursement event to the financial platform based on the entrusted withholding request; transferring a disbursement fund obtained after the event is executed to the fund account, and performing payment processing of the payment order based on the transferred fund. The disbursement fund is provided by the financial platform, and a fund amount of the disbursement fund is determined based on a payment amount of the payment order. The payment processing of the payment order specifically includes: transferring the disbursement fund from the fund account to an account of a merchant participating in the payment order; and if the payment processing of the payment order succeeds, writing bill information obtained after the payment processing to an entrusted withholding bill of the fund account.

As described above, as an actual fund expense party, the financial platform performs entrusted withholding of payment on the payment order of the institution member based on the fund account (for example, an escrow account) opened by the institution on the financial platform. Correspondingly, a fund disbursed by the financial platform for the payment order of the institution member of the institution needs to be repaid by the institution to the financial platform. To improve fund repayment efficiency, in an optional implementation provided in this embodiment, the financial platform performs withholding from a third-party fund account of the institution and/or the fund account based on the settlement term of the fund account. The financial platform performs withholding based on an authorization instruction submitted when the institution opens the fund account, and a withholding amount is determined through calculation based on bill information recorded in the entrusted withholding bill in the settlement term.

In practice, in many cases, refunding is needed for a payment order that has been paid. For example, an enterprise employee purchases a business trip ticket by using a reimbursement code of an enterprise, and a ticket fee is paid by using an escrow account that is opened by the enterprise on the financial institution and bound to the reimbursement code of the enterprise. Refund processing can be performed after payment is completed. Specifically, if a refund instruction of the payment order is detected, a fund is transferred from an account of a merchant participating in the payment order to the fund account; and the fund is transferred from the fund account to perform settlement processing for the borrowing disbursement, and bill information of the payment order recorded in the entrusted withholding bill is updated.

Because payment of the payment order of the institution member is generated based on the reimbursement code of the institution, reimbursement processing of the payment order can be performed after entrusted withholding processing of payment performed on the payment order of the institution member is completed by using the fund account opened by the institution on the financial platform. The reimbursement processing process includes e-bill application and reimbursement review. Specifically, e-bill application and reimbursement review processing can be performed by using the following method: transmitting the bill information of the payment order to a bill application link opened by a merchant, to generate an e-bill of the payment order; creating a reimbursement form of the institution member based on the e-bill and the bill information, to perform reimbursement review; and if the reimbursement review is passed, performing no processing or performing monitoring of the settlement term of the institution; or if the reimbursement review fails, performing a fund transfer operation from a member account of the institution member to a fund account of the institution or the fund account based on the bill information.

The e-bill described in this embodiment includes electronic invoices, receipts, and other electronic vouchers with voucher validity. The bill application link refers to a channel for issuing e-bills, for example, an electronic invoice issuing interface provided by tax authorities.

On this basis, to safeguard interests of the institution, and avoid a financial loss suffered by the institution when the institution provides the reimbursement code for the institution member to perform entrusted withholding processing of payment, in this embodiment, an insurance project is introduced to ensure financial interests when the institution provides the reimbursement code for entrusted withholding processing. Specifically, if the fund transfer operation fails, insurance claim settlement for an insurance project that the institution participates in is triggered; and if claim settlement verification is passed, a claim settlement fund is transferred to a fund account of the institution or the fund account based on an insurance amount, or a claim settlement fund is transferred to the fund account based on an order quota included in the bill information. It is worthwhile to note that the institution can apply to participate in the insurance project on its own, or a payment platform or a third-party platform can purchase and apply for participation on behalf of the institution, and the payment platform or the third-party platform is configured to perform the reimbursement code-based entrusted withholding processing method.

For example, an enterprise purchases insurance, or the payment platform purchases insurance for an enterprise that activates a reimbursement code. If reimbursement review of an enterprise employee fails, it indicates that a fund paid by the enterprise employee by using the reimbursement code needs to be borne by the enterprise employee, and withholding is performed from a fund account of the enterprise employee, to repay an advance to a financial platform that advances a fund. However, if withholding fails to be performed from the fund account of the enterprise employee, claim settlement of the insurance that the enterprise participates in is triggered, and a fund obtained through insurance claim settlement is used to repay the fund advanced by the financial platform.

In addition, there are still many cases in which reimbursement review fails and refund processing of the payment order is needed. For example, in an enterprise procurement scenario, a reason for a reimbursement review failure may be that purchased office items are not compliant with regulations. In this case, the purchased office items need to be returned, in other words, refund processing needs to be performed on a payment order generated in an office item procurement process. To improve rationality of reimbursement review and reduce impact of the reimbursement review failure on the institution member, in an optional implementation provided in this embodiment, if the reimbursement review fails, a fund is transferred from an account of an order participant of the payment order to the fund account; and the fund is transferred from the fund account to perform settlement processing for the borrowing disbursement, and the bill information in the entrusted withholding bill is updated.

The following further describes, by using an example of an application of the reimbursement code-based entrusted withholding processing method provided in this embodiment in an enterprise reimbursement scenario, the reimbursement code-based entrusted withholding processing method provided in this embodiment. Referring to FIG. 2, the reimbursement code-based entrusted withholding processing method applied to the enterprise reimbursement scenario specifically includes step S202 to step S218.
Step S202: Obtain a payment order submitted after a code scanning device configured by a merchant scans a reimbursement code displayed by a mobile terminal of an enterprise employee.

Before this, a reimbursement code access request submitted by the mobile terminal of the enterprise employee is obtained, and the reimbursement code of an enterprise is delivered to the mobile terminal for display on the mobile terminal.
Step S204: Perform expense control verification on the payment order of the enterprise employee based on an expense control rule configured for the reimbursement code of the enterprise.
Step S206: If the expense control verification is passed, detect whether the reimbursement code is bound to a fund account opened by the enterprise on a financial platform; and if yes, perform step S208 to step S212; or if no, perform payment on the payment order of the enterprise employee based on a fund account of the enterprise or a fund account bound to the reimbursement code.
Step S208: Generate an entrusted withholding request of the payment order, and submit the entrusted withholding request to the financial institution, to perform entrusted withholding processing of the payment order based on the fund account opened by the enterprise on the financial institution.

The entrusted withholding processing specifically includes: initiating borrowing disbursement to the financial institution based on the entrusted withholding request; transferring a disbursement fund obtained through borrowing disbursement to the fund account opened by the enterprise, and performing payment processing of the payment order based on the transferred fund; and if the payment processing of the payment order succeeds, writing bill information obtained after the payment processing to an entrusted withholding bill of the fund account opened by the enterprise.
Step S210: Transmit the bill information of the payment order to a bill application link opened by the merchant, to generate an e-bill of the payment order.
Step S212: Create a reimbursement form of the enterprise employee based on the e-bill and the bill information of the payment order, to perform reimbursement review.

In addition, the reimbursement form of the enterprise employee can alternatively be created based on the e-bill.
Step S214: If the reimbursement review fails, perform, based on the bill information of the payment order, a fund transfer operation from a fund account of the enterprise employee to the fund account opened by the enterprise.
Step S216: If the fund transfer operation fails, trigger insurance claim settlement for an insurance project that the enterprise participates in.
Step S218: If claim settlement verification is passed, transfer, based on an insurance amount, a claim settlement fund to the fund account opened by the enterprise, or transfer, based on an order quota included in the bill information, a claim settlement fund to the fund account opened by the enterprise.

The reimbursement code-based entrusted withholding processing method is provided in the above-mentioned embodiments. Correspondingly, a reimbursement code-based entrusted withholding processing apparatus is further provided. The following describes the entrusted withholding processing apparatus with reference to the accompanying drawings.

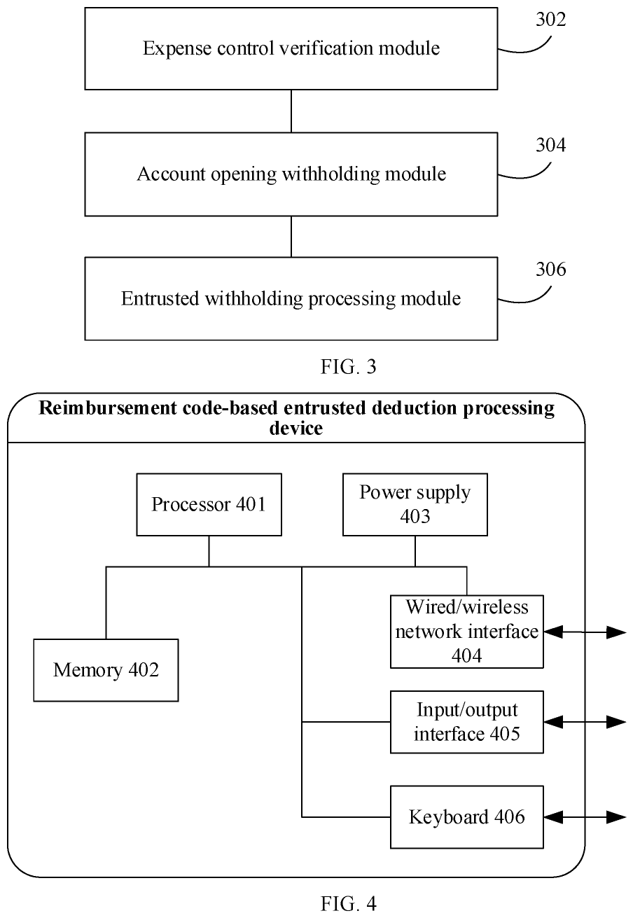

FIG. 3 is a schematic diagram illustrating a reimbursement code-based entrusted withholding processing apparatus, according to an embodiment.

The apparatus embodiment corresponds to the method embodiment, and therefore, is described briefly. For a related part, references can be made to the corresponding descriptions of the method embodiment provided above. The apparatus embodiment described below is merely an example.

This embodiment of this specification provides a reimbursement code-based entrusted withholding processing apparatus, including: an expense control verification module 302, configured to perform expense control verification on a payment order of an institution member based on an expense control rule configured for a reimbursement code of an institution; an account opening detection module 304, configured to: if the expense control verification is passed, detect whether the reimbursement code is bound to a fund account opened by the institution on a financial platform, where if yes, an entrusted withholding processing module 306 is run; and the entrusted withholding processing module 306, configured to generate an entrusted withholding request of the payment order, and submit the entrusted withholding request to the financial platform, to perform entrusted withholding processing of the payment order based on the fund account.

Corresponding to the reimbursement code-based entrusted withholding processing method described above, based on the same technical concept, one or more embodiments of this specification further provide a reimbursement code-based entrusted withholding processing device. The reimbursement code-based entrusted withholding processing device is configured to perform the reimbursement code-based entrusted withholding processing method provided above. FIG. 4 is a schematic diagram illustrating a structure of a reimbursement code-based entrusted withholding processing device, according to one or more embodiments of this specification.

As shown in FIG. 4, the reimbursement code-based entrusted withholding processing device can change greatly with configuration or performance, and can include one or more processors 401 and memories 402. The memory 402 can store one or more storage applications or data. The memory 402 can be used for transient storage or persistent storage. The applications stored in the memory 402 can include one or more modules (not shown in the figure), and each module can include a series of computer executable instructions in the reimbursement code-based entrusted withholding processing device. Still further, the processor 401 can be configured to communicate with the memory 402 to execute a series of computer executable instructions in the memory 402 on the reimbursement code-based entrusted withholding processing device. The reimbursement code-based entrusted withholding processing device can further include one or more power supplies 403, one or more wired or wireless network interfaces 404, one or more input/output interfaces 405, one or more keyboards 406, etc.

In a specific embodiment, the reimbursement code-based entrusted withholding processing device includes a memory and one or more programs. The one or more programs are stored in the memory, and the one or more programs can include one or more modules. Each module can include a series of computer executable instructions in the reimbursement code-based entrusted withholding processing device, and one or more processors are configured to execute the computer executable instructions included in the one or more programs to perform the following operations: performing expense control verification on a payment order of an institution member based on an expense control rule configured for a reimbursement code of an institution; if the expense control verification is passed, detecting whether the reimbursement code is bound to a fund account opened by the institution on a financial platform; and if yes, generating an entrusted withholding request of the payment order, and submitting the entrusted withholding request to the financial platform, to perform entrusted withholding processing of the payment order based on the fund account.

Optionally, the entrusted withholding processing includes: initiating borrowing disbursement to the financial platform based on the entrusted withholding request; transferring a disbursement fund obtained through borrowing disbursement to the fund account, and performing payment processing of the payment order based on the transferred fund; and if the payment processing of the payment order succeeds, writing bill information obtained after the payment processing to an entrusted withholding bill of the fund account.

Optionally, the financial platform performs withholding from a third-party fund account of the institution and/or the fund account based on a settlement term of the fund account. The financial platform performs withholding based on an authorization instruction submitted when the institution opens the fund account, and a withholding amount is determined through calculation based on bill information recorded in the entrusted withholding bill in the settlement term.

Optionally, when the computer executable instructions are executed, the following operations are further included: if a refund instruction of the payment order is detected, transferring a fund from an account of a merchant participating in the payment order to the fund account; and transferring the fund from the fund account to perform settlement processing for the borrowing disbursement, and updating bill information of the payment order recorded in the entrusted withholding bill.

Optionally, when the computer executable instructions are executed, the following operations are further included: transmitting the bill information of the payment order to a bill application link opened by a merchant, to generate an e-bill of the payment order; creating a reimbursement form of the institution member based on the e-bill and the bill information, to perform reimbursement review; and if the reimbursement review fails, performing a fund transfer operation from a member account of the institution member to a fund account of the institution or the fund account based on the bill information.

Optionally, when the computer executable instructions are executed, the following operations are further included: if the fund transfer operation fails, triggering insurance claim settlement for an insurance project that the institution participates in; and if claim settlement verification is passed, transferring a claim settlement fund to a fund account of the institution or the fund account based on an insurance amount, or transferring a claim settlement fund to the fund account based on an order quota included in the bill information.

Corresponding to the reimbursement code-based entrusted withholding processing method described above, based on the same technical concept, one or more embodiments of this specification further provide a storage medium.

The storage medium provided in this embodiment is configured to store computer executable instructions. When the computer executable instructions are executed, the following procedure is implemented: performing expense control verification on a payment order of an institution member based on an expense control rule configured for a reimbursement code of an institution; if the expense control verification is passed, detecting whether the reimbursement code is bound to a fund account that the institution has opened on a financial platform; and if yes, generating an entrusted withholding request of the payment order, and submitting the entrusted withholding request to the financial platform, to perform entrusted withholding processing of the payment order based on the fund account.

Optionally, the entrusted withholding processing includes: initiating borrowing disbursement to the financial platform based on the entrusted withholding request; transferring a disbursement fund obtained through borrowing disbursement to the fund account, and performing payment processing of the payment order based on the transferred fund; and if the payment processing of the payment order succeeds, writing bill information obtained after the payment processing to an entrusted withholding bill of the fund account.

Optionally, the financial platform performs withholding from a third-party fund account of the institution and/or the fund account based on a settlement term of the fund account. The financial platform performs withholding based on an authorization instruction submitted when the institution opens the fund account, and a withholding amount is determined through calculation based on bill information recorded in the entrusted withholding bill in the settlement term.

Optionally, when the computer executable instructions are executed, the following procedure is further implemented: if a refund instruction of the payment order is detected, transferring a fund from an account of a merchant participating in the payment order to the fund account; and transferring the fund from the fund account to perform settlement processing for the borrowing disbursement, and updating bill information of the payment order recorded in the entrusted withholding bill.

Optionally, when the computer executable instructions are executed, the following procedure is further implemented: transmitting the bill information of the payment order to a bill application link opened by a merchant, to generate an e-bill of the payment order; creating a reimbursement form of the institution member based on the e-bill and the bill information, to perform reimbursement review; and if the reimbursement review fails, performing a fund transfer operation from a member account of the institution member to a fund account of the institution or the fund account based on the bill information.

Optionally, when the computer executable instructions are executed, the following procedure is further implemented: if the fund transfer operation fails, triggering insurance claim settlement for an insurance project that the institution participates in; and if claim settlement verification is passed, transferring a claim settlement fund to a fund account of the institution or the fund account based on an insurance amount, or transferring a claim settlement fund to the fund account based on an order quota included in the bill information.

It is worthwhile to note that the embodiment of the storage medium in this specification and the embodiment of the reimbursement code-based entrusted withholding processing method in this specification are based on the same inventive concept. Therefore, for specific implementation of this embodiment, references can be made to the implementation of the above-mentioned corresponding method, and repeated parts are omitted for simplicity.

Some specific embodiments of this specification are described above. Other embodiments fall within the scope of the appended claims. In some situations, the actions or steps described in the claims can be performed in an order different from the order in the embodiments and the desired results can still be achieved. In addition, the process depicted in the accompanying drawings does not necessarily need a particular execution order to achieve the desired results. In some implementations, multi-tasking and concurrent processing is feasible or can be advantageous.

In the 1930s, whether a technical improvement is a hardware improvement (for example, an improvement to a circuit structure such as a diode, a transistor, or a switch) or a software improvement (an improvement to a method procedure) can be clearly distinguished. However, as technologies develop, current improvements to many method procedures can be considered as direct improvements to hardware circuit structures. A designer usually programs an improved method procedure into a hardware circuit, to obtain a corresponding hardware circuit structure. Therefore, a method procedure can be improved by using a hardware entity module. For example, a programmable logic device (PLD) (for example, a field programmable gate array (FPGA)) is such an integrated circuit, and a logical function of the programmable logic device is determined by a user through device programming. The designer performs programming to “integrate” a digital system to a PLD without requesting a chip manufacturer to design and produce an application-specific integrated circuit chip. In addition, at present, instead of manually manufacturing an integrated circuit chip, this type of programming is mostly implemented by using “logic compiler” software. The programming is similar to a software compiler used to develop and write a program. Original code needs to be written in a particular programming language for compilation. The language is referred to as a hardware description language (HDL). There are many HDLs, such as the Advanced Boolean Expression Language (ABEL), the Altera Hardware Description Language (AHDL), Confluence, the Cornell University Programming Language (CUPL), HDCal, the Java Hardware Description Language (JHDL), Lava, Lola, MyHDL, PALASM, and the Ruby Hardware Description Language (RHDL). The very-high-speed integrated circuit hardware description language (VHDL) and Verilog are most commonly used. A person skilled in the art should also understand that a hardware circuit that implements a logical method procedure can be readily obtained once the method procedure is logically programmed by using the several described hardware description languages and is programmed into an integrated circuit.

A controller can be implemented by using any appropriate method. For example, the controller can be a microprocessor or a processor, or a computer readable medium that stores computer-readable program code (such as software or firmware) that can be executed by the microprocessor or the processor, a logic gate, a switch, an application-specific integrated circuit (ASIC), a programmable logic controller, or a built-in microprocessor. Examples of the controller include but are not limited to the following microprocessors: ARC 625D, Atmel AT91SAM, Microchip PIC18F26K20, and Silicone Labs C8051F320. The memory controller can also be implemented as a part of the control logic of the memory. A person skilled in the art also knows that, in addition to implementing the controller by using only the computer-readable program code, logic programming can be performed on method steps to enable the controller to implement the same function in forms of the logic gate, the switch, the application-specific integrated circuit, the programmable logic controller, the embedded microcontroller, etc. Therefore, the controller can be considered as a hardware component, and an apparatus configured to implement various functions in the controller can also be considered as a structure in the hardware component. Or the apparatus configured to implement various functions can even be considered as both a software module implementing the method and a structure in the hardware component.

The system, apparatus, module, or unit illustrated in the above-mentioned embodiments can be specifically implemented by using a computer chip or an entity, or can be implemented by using a product having a specific function. A typical implementation device is a computer. Specifically, the computer can be, for example, a personal computer, a laptop computer, a cellular phone, a camera phone, a smartphone, a personal digital assistant, a media player, a navigation device, an email device, a game console, a tablet computer, a wearable device, or any combination of these devices.

For ease of description, the apparatus above is described by dividing functions into various units. Certainly, when the embodiments of this specification are implemented, functions of the units can be implemented in one or more pieces of software and/or hardware.

A person skilled in the art should understand that one or more embodiments of this specification can be provided as a method, a system, or a computer program product. Therefore, the one or more embodiments of this specification can use a form of hardware only embodiments, software only embodiments, or embodiments with a combination of software and hardware. In addition, a form of a computer program product that is implemented on one or more computer-usable storage media (including but not limited to a disk memory, a compact disc read-only memory (CD-ROM), an optical memory, etc.) that include computer-usable program code can be used in this specification.

This specification is described with reference to the flowcharts and/or block diagrams of the method, the device (system), and the computer program product based on the embodiments of this specification. It is worthwhile to note that computer program instructions can be used to implement each process and/or each block in the flowcharts and/or the block diagrams and a combination of a process and/or a block in the flowcharts and/or the block diagrams. These computer program instructions can be provided for a general-purpose computer, a dedicated computer, an embedded processor, or a processor of another programmable data processing device to generate a machine, so the instructions executed by the computer or the processor of the another programmable data processing device generate an apparatus for implementing a specific function in one or more processes in the flowcharts and/or in one or more blocks in the block diagrams.

These computer program instructions can be stored in a computer readable memory that can instruct the computer or the another programmable data processing device to work in a specific way, so the instructions stored in the computer readable memory generate an artifact that includes an instruction apparatus. The instruction apparatus implements a specific function in one or more processes in the flowcharts and/or in one or more blocks in the block diagrams.

These computer program instructions can be loaded onto the computer or the another programmable data processing device, so that a series of operation steps are performed on the computer or the another programmable device, thereby generating computer-implemented processing. Therefore, the instructions executed on the computer or the another programmable device provide steps for implementing a specific function in one or more processes in the flowcharts and/or in one or more blocks in the block diagrams.

In a typical configuration, a computing device includes one or more central processing units (CPUs), input/output interfaces, network interfaces, and memories.

The memory can include a non-persistent memory, a random access memory (RAM), a non-volatile memory, and/or another form that are in a computer readable medium, for example, a read-only memory (ROM) or a flash memory (flash RAM). The memory is an example of the computer readable medium.

The computer readable medium includes persistent, non-persistent, movable, and unmovable media that can store information by using any method or technology. The information can be a computer readable instruction, a data structure, a program module, or other data. Examples of the computer storage medium include but are not limited to a phase change random access memory (PRAM), a static random access memory (SRAM), a dynamic random access memory (DRAM), a random access memory (RAM) of another type, a read-only memory (ROM), an electrically erasable programmable read-only memory (EEPROM), a flash memory or another memory technology, a compact disc read-only memory (CD-ROM), a digital versatile disc (DVD) or another optical storage, a cassette, a magnetic disk storage or another magnetic storage device, or any other non-transmission medium. The computer storage medium can be configured to store information that can be accessed by a computing device. Based on the definition in this specification, the computer readable medium does not include transitory media such as a modulated data signal and carrier.

It is worthwhile to further note that, the terms “include”, “contain”, or their any other variants are intended to cover a non-exclusive inclusion, so a process, a method, a product or a device that includes a list of elements not only includes those elements but also includes other elements which are not expressly listed, or further includes elements inherent to such process, method, product or device. Without more constraints, an element preceded by “includes a . . . ” does not preclude the existence of additional identical elements in the process, method, product, or device that includes the element.

One or more embodiments of this specification can be described in the general context of computer executable instructions, for example, a program module. Generally, the program module includes a routine, a program, an object, a component, a data structure, etc. executing a specific task or implementing a specific abstract data type. One or more embodiments of this specification can also be practiced in distributed computing environments. In the distributed computing environments, tasks are performed by remote processing devices that are connected through a communication network. In the distributed computing environments, the program module can be located in both local and remote computer storage media including storage devices.

The embodiments of this specification are described in a progressive way. For same or similar parts of the embodiments, mutual references can be made to the embodiments. Each embodiment focuses on a difference from other embodiments. Particularly, a system embodiment is similar to a method embodiment, and therefore is described briefly. For related parts, references can be made to related descriptions in the method embodiment.

The above-mentioned descriptions are merely embodiments of this specification and are not intended to limit this specification. A person skilled in the art can make various modifications and changes to this specification. Any modification, equivalent replacement, or improvement made without departing from the spirit and principle of this specification shall fall within the scope of the claims of this specification.

1. An entrusted withholding processing method, comprising:
performing expense control verification on a payment order of an institution member based on an expense control rule configured for a reimbursement code of an institution;
upon determining that the expense control verification is passed, detecting whether the reimbursement code is bound to a fund account opened by the institution on a financial platform; and
upon determining that the reimbursement code is bound to the fund account opened by the institution on the financial platform, generating an entrusted withholding request of the payment order, and submitting the entrusted withholding request to the financial platform, to perform entrusted withholding processing of the payment order based on the fund account.

2. The entrusted withholding processing method according to claim 1, wherein the entrusted withholding processing comprises:
initiating borrowing disbursement to the financial platform based on the entrusted withholding request;
transferring a disbursement fund obtained through borrowing disbursement to the fund account, and performing payment processing of the payment order based on the transferred fund; and
upon determining that the payment processing of the payment order succeeds, writing bill information obtained after the payment processing to an entrusted withholding bill of the fund account.

3. The entrusted withholding processing method according to claim 2, wherein the financial platform performs withholding from a third-party fund account of the institution and/or the fund account based on a settlement term of the fund account; and
the financial platform performs withholding based on an authorization instruction submitted when the institution opens the fund account, and a withholding amount is determined through calculation based on bill information recorded in the entrusted withholding bill in the settlement term.

4. The entrusted withholding processing method according to claim 2, further comprising:
upon determining that a refund instruction of the payment order is detected, transferring a fund from an account of a merchant participating in the payment order to the fund account; and
transferring the fund from the fund account to perform settlement processing for the borrowing disbursement, and updating bill information of the payment order recorded in the entrusted withholding bill.

5. The entrusted withholding processing method according to claim 2, further comprising:
transmitting the bill information of the payment order to a bill application link opened by a merchant, to generate an e-bill of the payment order;
creating a reimbursement form of the institution member based on the e-bill and the bill information, to perform reimbursement review; and
upon determining that the reimbursement review fails, performing a fund transfer operation from a member account of the institution member to a fund account of the institution or the fund account based on the bill information.

6. The entrusted withholding processing method according to claim 5, further comprising:
upon determining that the fund transfer operation fails, triggering insurance claim settlement for an insurance project that the institution participates in; and
upon determining that claim settlement verification is passed, transferring a claim settlement fund to a fund account of the institution or the fund account based on an insurance amount, or transferring a claim settlement fund to the fund account based on an order quota comprised in the bill information.

7. The entrusted withholding processing method according to claim 1, wherein the fund account is opened by using the following method:
opening the fund account of the institution based on an account application submitted by the institution, and signing a term withholding agreement in which the financial platform performs withholding for a disbursement fund of the fund account based on a settlement term; and
establishing a binding relationship between the fund account and the reimbursement code.

8. The entrusted withholding processing method according to claim 1, wherein upon determining that the expense control verification fails, payment failure reminder information is delivered to the institution member, and/or payment processing of the payment order is performed based on a member account of the institution member.

9. The entrusted withholding processing method according to claim 5, further comprising:
upon determining that the reimbursement review fails, transferring a fund from an account of an order participant of the payment order to the fund account; and
transferring the fund from the fund account to perform settlement processing for the borrowing disbursement, and updating the bill information in the entrusted withholding bill.

10. The entrusted withholding processing method according to claim 1, wherein the performing expense control verification on a payment order of an institution member based on an expense control rule configured for a reimbursement code of an institution comprises:
determining a target reimbursement category that matches the payment order in at least one reimbursement category of the expense control rule;
verifying whether element information recorded in the payment order falls within a value range of an expense control element associated with the target reimbursement category; and
upon determining that the element information falls within the value range of the expense control element associated with the target reimbursement category, determining that the payment order passes the verification on the target reimbursement category.

11. The entrusted withholding processing method according to claim 10, wherein the at least one reimbursement category of the reimbursement code is configured in the expense control rule, and the reimbursement category is associated with at least one expense control element; and
the expense control element comprises at least one of the following: a time element, an object compliance element, a quota element, and a location element.

12. (canceled)

13. An entrusted withholding processing device, comprising:
a memory and a processor, wherein the memory stores executable instructions that, in response to execution by the processor, cause the processor to:
perform expense control verification on a payment order of an institution member based on an expense control rule configured for a reimbursement code of an institution;
upon determining that the expense control verification is passed, detect whether the reimbursement code is bound to a fund account opened by the institution on a financial platform; and
upon determining that the reimbursement code is bound to the fund account opened by the institution on the financial platform, generate an entrusted withholding request of the payment order, and submit the entrusted withholding request to the financial platform, to perform entrusted withholding processing of the payment order based on the fund account.

14. A non-transitory storage medium, comprising instructions stored therein that, when executed by a processor of a computing device, cause the processor to:
perform expense control verification on a payment order of an institution member based on an expense control rule configured for a reimbursement code of an institution;
upon determining that the expense control verification is passed, detect whether the reimbursement code is bound to a fund account opened by the institution on a financial platform; and
upon determining that the reimbursement code is bound to the fund account opened by the institution on the financial platform, generate an entrusted withholding request of the payment order, and submit the entrusted withholding request to the financial platform, to perform entrusted withholding processing of the payment order based on the fund account.
